(19) United States
(12) Patent Application Publication
(10) Pub. No.: US 2025/0290894 A1
(43) Pub. Date: Sep. 18, 2025

(54) SURFACE MODIFIED CAPILLARY FOR ELECTROPHORESIS AND METHOD FOR CONSTRUCTION THEREOF

(71) Applicant: GMJ TECHNOLOGIES, INC., Seattle, WA (US)

(72) Inventor: Oluwatosin O. Dada, Everett, WA (US)

(21) Appl. No.: 19/079,159

(22) Filed: Mar. 13, 2025

Related U.S. Application Data
(60) Provisional application No. 63/564,858, filed on Mar. 13, 2024.

(51) Int. Cl. G01N 27/447; C08F 292/00; C09C 1/30

(52) U.S. Cl. CPC G01N 27/44704; C08F 292/00; C09C 1/3045; C09C 1/3063; C09C 1/3072; C09C 1/309; G01N 27/44791

(57) ABSTRACT

A method for coating a surface of fused silica material is provided. A surface of a piece of material is pre-conditioned with a hydrolyzing reagent creating an Si—OH or R—OH bond on the surface. The surface is covered with thionyl chloride for a predetermined amount of time converting the Si—OH bond on the surface to an Si—Cl. The thionyl chloride is removed and the surface is covered with a compound or mixture having an amine group converting the Si—Cl bond to an Si—N—R bond. The compound or mixture is removed.

This invention was made with government support under Grant No. 1R44GM156142 awarded by the National Institutes of Health. The government has certain rights in the invention.

### FIELD

This invention relates in general, to capillary electrophoresis and in particular, to a method for capillary modification and a modified capillary thereof.

### BACKGROUND

Capillary electrophoresis (CE) is a powerful charge-based separation process that enables fast and efficient analysis of proteins without buffer matrix interference or stationary phase interaction that may degrade the resolution of the CE separating proteins. During free zone CE, a sample of analytes containing proteins or other chemical or biochemical species, is introduced into a capillary filled with background electrolyte. Migration of the analyte through the capillary is initiated by an electrical field that is applied and the analytes are separated based on their charge-to-size ratio driven by the combination of electroosmotic flow (EOF) and electrophoretic mobility. The separated analytes are detected at an outlet end of the capillary, opposite the end used for sample introduction, one of several established optical detection methods or mass spectrometry (MS).

CE is particularly suitable for the analysis of proteins and other biomolecules because it can allow separation conditions that mimic the physiologic conditions. The separation can be performed on a bare fused-silica capillary but protein adsorption to the inner surface of the capillary severely degrades the resolution and analyte's recovery. As a result, capillary surface treatment is essential to achieve good resolution. For instance, protein analysis by CE often requires the use of capillary coatings to minimize protein adsorption, suppress electroosmotic flow to enhance resolution, including of the proteins, and separation efficiency. Covalently bound neutral coating polymers are usually employed for this purpose. Several neutral coating methods have been previously reported but the most widely used is based on modification of the silica surface with linear polyacrylamide (LPA).

Conventional LPA coating is based on free radical polymerization reactions where the inner wall of the capillary is first modified with a silane compound, such as γ-methacryloxypropyltrimethoxysilane (MAPS). Then, the pretreated capillary is filled with a de-aerated polymerization mixture, typically composed of the acrylamide, ammonium persulphate (APS) with or without N,N,N′,N′-tetramethylethylenediamine (TEMED). CE of proteins on linear polyacrylamide-coated capillaries have been extensively reported but the coating stability is usually a challenge, degrading the resolution over time. Further, commercial coated capillaries are scarce and expensive, forcing individual labs to prepare custom coatings every time a coated capillary is needed.

Therefore, a need remains for a stable coated capillary that produces separation of proteins with a high-resolution separation. Preferably, results of the protein separation are sufficient for detection via mass spectrometry. Such capillary would be valuable to researchers in academic, private, and government research labs.

### SUMMARY

A surface coating method utilizes formamide catalyzed chlorination of the silanol (Si—OH) group of a fused silica (quartz) surface, followed by surface reaction with a nucleophilic substrate to create varieties of functional groups or introduce a chain transfer layer for a subsequent polymerization. The chlorination method is applicable in other surface materials presenting R—OH or R—COOH functional groups, where there is any other surface substrate other than Silicon. In one configuration, the hydroxyl group of the silica surface of a capillary surface is converted to a halide group such as chloride. Then, Friedel Craft amination is used to attach acrylamide via an amine group to the chlorinated silica surface. The pretreated capillary is filled with a de-aerated mixture of acrylamide or poly ethylene glycol methacrylate (PEGM), ammonium persulphate (APS), and N,N,N′,N′-tetramethylethylenediamine (TEMED). In a further embodiment, other transfer-chain agents can be used in the Friedel Craft reaction step to generate any of Si—N, Si—C, Si—O, R—N, R—C, or R—O bonds where R is any surface substrate other than Silicon, acrylamide by itself can be used, without the PEGM, or PEGM, without acrylamide, or other monomers can be used for the polymerization.

An embodiment for coating a surface of fused silica material is provided. A surface of a piece of material is pre-conditioned with a hydrolyzing reagent, such as NaOH, creating an Si—OH or R—OH bond on the surface. The surface is then treated with thionyl chloride for a predetermined amount of time converting the Si—OH bond on the surface to an Si—Cl. The thionyl chloride is removed and the surface is treated with a compound or mixture having an amine group converting the Si—Cl bond to an Si—N—R bond. The compound or mixture is removed.

Still other embodiments will become readily apparent to those skilled in the art from the following detailed description, wherein are described embodiments by way of illustrating the best mode contemplated. As will be realized, other and different embodiments are possible and the embodiments' several details are capable of modifications in various obvious respects, all without departing from their spirit and the scope. Accordingly, the drawings and detailed description are to be regarded as illustrative in nature and not as restrictive.

### BRIEF DESCRIPTION OF THE DRAWINGS

FIG. 1 is a flow diagram showing, by way of example, the changes to the surface chemistry during capillary surface modification.

FIG. 2 is a flow diagram showing, by way of example, a method for performing capillary modification.

FIG. 3 is a block diagram showing, by way of example, an inner surface of one side of a preconditioned capillary with Si—OH bonds.

FIG. 4 is a block diagram showing, by way of example, an inner surface of one side of a capillary with Si—Cl bonds after chlorination.

FIG. 5 is a block diagram showing, by way of example, an alternate process for modification of the Si—OH bonds on the capillary surface to Si—Cl bonds.

FIG. 6 is a block diagram showing, by way of example, another alternative process for modification of the Si—OH bonds on the capillary surface to Si—Cl bonds and the chemical structure of TCT.

FIG. 7 is a block diagram showing, by way of example, modification of the Si—Cl bonds on the capillary surface to Si—N—R bonds, where R is any amine containing compound.

FIG. 8 is a block diagram showing, by way of example, an interior of the capillary after polymerization.

FIG. 9 is a graph diagram showing results of capillary electrophoresis using capillaries with different surface coatings.

FIG. 10 is a graph showing analysis of a protein showing (A) the inline UV electropherograms generated with a capillary coated with LPA capillary, and (B) a capillary coated with LPA-PEGM co-polymer.

FIG. 11 is a block diagram showing, by way of example, an interior of the capillary with polymer chains.

FIG. 12 is a block diagram showing, by way of example, an interior of the capillary with electroosmotic flow.

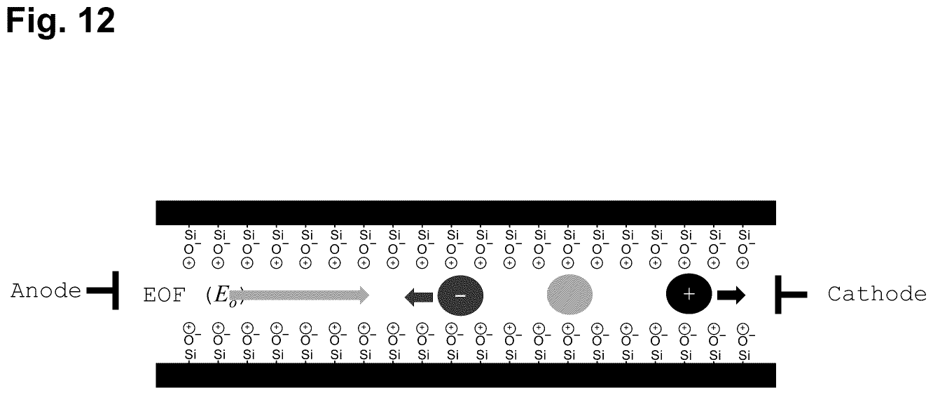

### DETAILED DESCRIPTION

To obtain optimal CE resolution of proteins, capillary coatings should be used to minimize protein adsorption, suppress electroosmotic flow, and enhance separation efficiency. Conventional coating methods utilize linear polyacrylamide, which provide limited resolution, not sufficient for use with applications such as in (native) mass spectroscopy. However, a process that includes chlorination, amination or alkylation, and polymerization forms polymer chains that help reduce osmotic flow in the capillary and prevent protein adsorption during electrophoresis.

In one embodiment, a coating method that uses acrylamide by itself, or acrylamide as the chain-transfer layer with LPA-PEGM co-polymer provides resolution sufficient for use with mass spectroscopy. When acrylamide is used by itself, the acrylamide coating procedure can use Friedel Craft amination to attach acrylamide via the amine group to the silica surface. For instance, acrylamide can be used as the transfer chain and an amine group of the acrylamide can react with the chlorinated silica surface to form an Si—N bond. Acrylamide has a double bond, which can bring in all the acrylamide monomers that will start to grow the polymer from an initial acrylamide transfer applied to get a pure acrylamide surface coating the capillary. However, in a separate embodiment, acrylamide can be replaced with other compounds with amine groups, including tris(hydroxymethyl)aminomethane to create a monolayer surface coating.

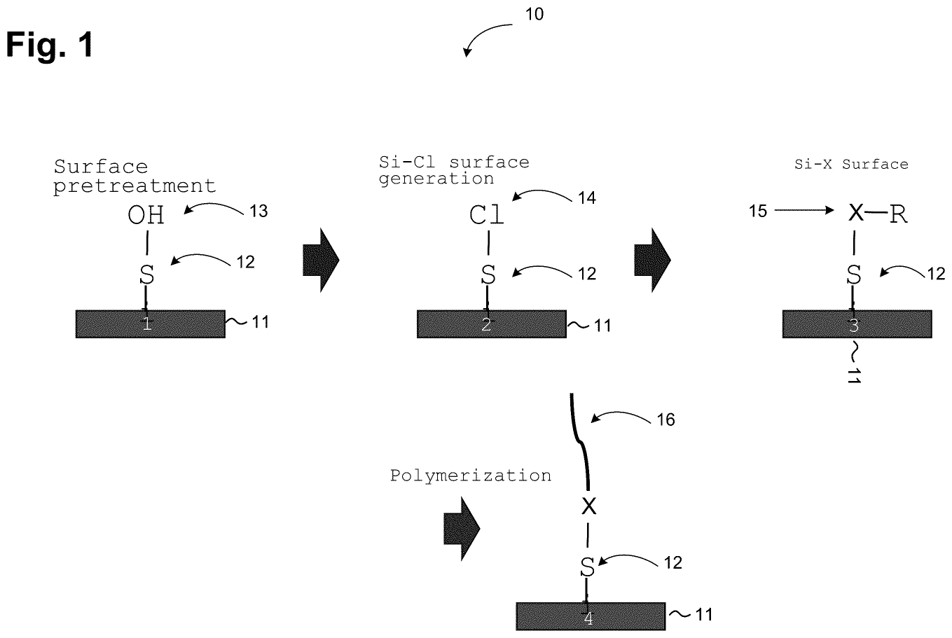

Capillary surface modification includes multiple steps. FIG. 1 is a flow diagram showing, by way of example, a mechanism of capillary surface modification. Generally, interior surfaces of a capillary are characterized with silanol groups, where the hydroxyl groups 13 attach to the silicon 12. To prevent proteins from sticking to the surface during electrophoresis, the capillary surface can be treated or modified. First, the silanol 12 interior surfaces of the capillary 11 can be preconditioned with NaOH rinse followed by water and methanol rinse. Treating the capillary with NaOH catalyzes conversion of the hydrated silica to silanol. Next, the Si—OH bond on the capillary surface is converted to an Si—Cl bond, during a chlorination step, where Chloride 14 is attached to the Silicon. After, a conversion can be performed to convert the Si—Cl bond to a Si—X bond, where X can include Nitrogen, Carbon, or Oxygen.

When nitrogen is used, an amine group can represented by N—R, where R can be any monomeric compound, such as tris(hydroxymethyl)aminomethane. A neutral R group of the amine compound can suppress EOF and prevent protein adsorption. R groups with a net positive or negative charge can be used to modulate the EOF to a desired degree and direction. However, as described above, Oxygen, Carbon, or other elements can replace the Nitrogen.

The modification process can terminate at this point, and the capillary can be ready for use for CE. However, an additional step can optionally be performed in which the Si-amine layer acts as the transfer-chain on which polymerization occurs to generate polymer chains 16. For polymerization to occur, the amine compound must present a terminal double bond.

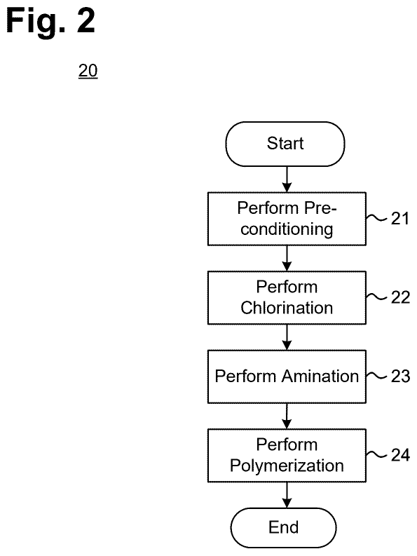

One or more of the steps described above can be performed via different processes. FIG. 2 is a flow diagram showing, by way of reference a process 20 for capillary modification. A fused silica capillary is obtained and prepared for modification using capillary pre-conditioning (step 21), which activates the silica surface of the capillary to an Si—OH surface. During pre-conditioning, the fused silica capillary inner surface can be hydrolyzed with 1 Molar NaOH rinse for 1 hour, or more or less than an hour. Subsequently, the capillary can be washed with distilled de-ionized water for 30 minutes or more, followed by rinsing the capillary with methanol for 30 minutes or more. Rinsing with methanol is optional to ensure removal of any surface contaminants. Wash and rinse times can be longer or shorter than 30 minutes. Next, the capillary can be dried with nitrogen gas or any inert gas for 15 minutes, or shorter or longer times. After, the capillary can be baked in a dry oven at 80° C. or higher for 30 minutes or more. In one embodiment, the capillary can be baked at temperatures up to around 400° C.

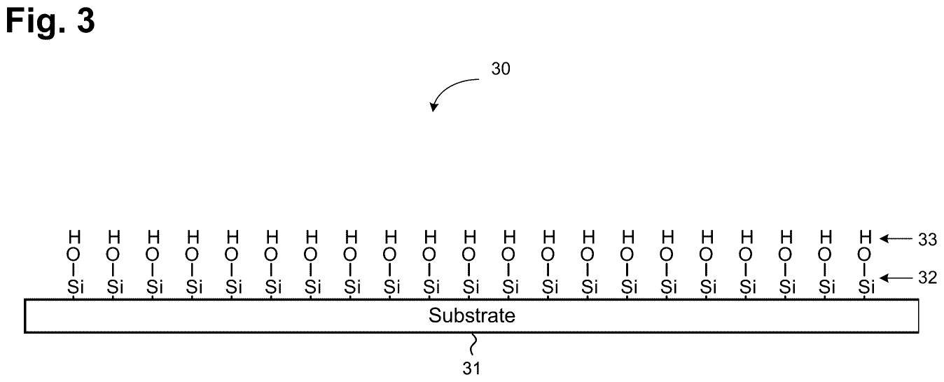

During the pre-conditioning stage, the capillary is hydrolyzed to silanol groups. FIG. 3 is a block diagram showing, by way of example, an inner surface 30 of one side of a capillary 31 with Si—OH bonds. The inner surface of a capillary is generally a fused silica surface 32, which includes hydroxyl groups 33.

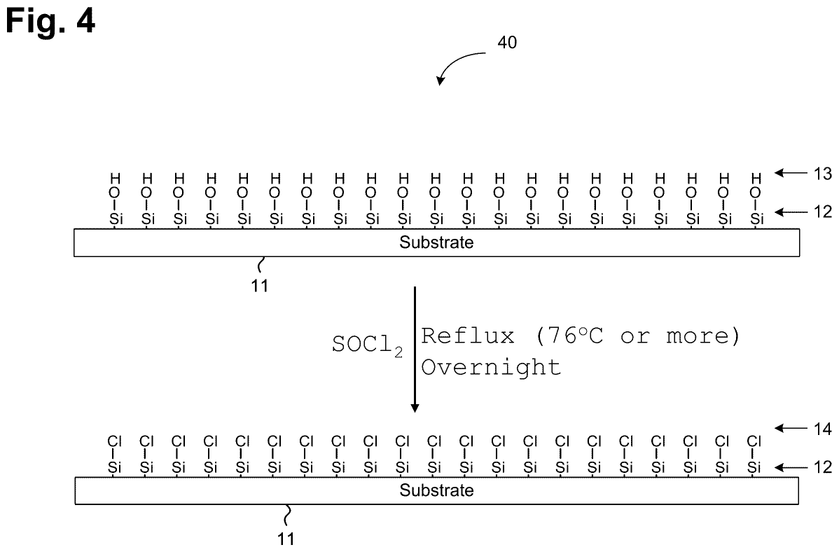

Returning to the discussion with respect to FIG. 2, after preconditioning, chlorination (step 22) can be performed to convert the Si—OH bonds to Si—Cl. During chlorination, the preconditioned capillary can be filled with thionyl chloride (SOCl₂) and allowed to incubate overnight at around 80° C. with both ends of the capillary sealed. However, other temperatures are possible, such as within a range of 76° C. and above. A minimum time of incubation is around 1 hour or longer. Use of the thionyl chloride allows conversion of the OH group on the silica surface of the capillary to chloride. Halides, including chloride, bromine, and iodine are better leaving groups than hydroxyl (OH). Specifically, halides are a conjugate base of a strong acid, such as HCl, while hydroxide is a conjugate base of a weak acid, such as water, making chloride a weak base and a thus, a more stable leaving group. FIG. 4 is a block diagram showing, by way of example, transforming an inner capillary surface having Si—OH bonds to Si—Cl bonds. The hydroxyl groups 13, attached to the silicon 12 surface of the capillary 11, are replaced with chloride 14.

Other processes for converting the hydroxyl group on the silica surface to chloride are possible. For example, the preconditioned capillary can be filled with a mixture of up to 50% (v/v) thionyl chloride (SOCl₂) in dichloromethane (DCM), chlorobenzene or tetrahydrofuran (THF), and incubated at 80° C. overnight. In one embodiment, only the listed components are included in the mixture. However, in a further embodiment, any balance remaining of the mixture can be fulfilled with water or another substance. Other temperatures are possible, such as within a range of 76° C. and above. A minimum time of incubation is around 1 hour or longer. The SOCl₂ can be added slowly to the DCM, chlorobenzene or THF and mixed gently. In one embodiment, the capillary can be cut into 1-2 meter segments to help improve flow through the capillary and reduce clogging for subsequent steps.

In a further embodiment, the Si—OH surface can be converted to Si—Cl by first, generating a Vilsmeier-Haack reagent and then applying the Vilsmeier-Haack reagent to the capillary. The Vilsmeier-Haack reagent is an iminium salt generated from formamide and SOCl₂ intermediate reaction and can be made by adding SOCl₂ to formamide in a suitable solvent such as DCM, chlorobenzene, or THF and mixing properly in a uniform manner. In one configuration, Dimethyl Formamide (DMF) can be slowly added to the SOCl₂ and chlorobenzene (or DCM, THF) mixture, and time for the DMF to diffuse into the solution should be provided before mixing. Fast DMF mixing could cause aggressive reaction, which can result in a gas explosion. The time for DMF is diffuse can be 5-10 minutes or longer, including storage time. DMF can be replaced with other formamides.

The Vilsmeier-Haack reagent can include 25% (v/v) SOCl₂+25% (v/v) DMF (catalyst) in DCM, chlorobenzene or THF; however, other percentages are possible. For instance, DMF can be as low as 0.01%, while SOCl₂ can be as low as 0.01%. Any remaining weight or volume not accounted for by other components, can include water. In one embodiment, only the listed components are included in the mixture. However, in a further embodiment, any balance remaining of the mixture can be fulfilled with water or another substance.

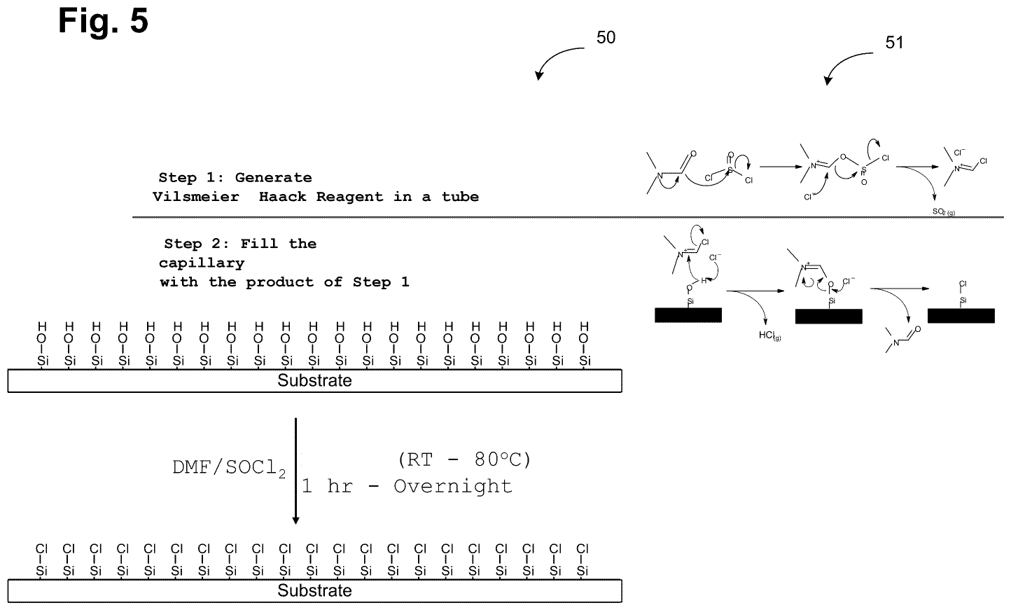

Once generated, the Vilsmeier-Haack reagent can fill the capillary, which can be incubated at around 80° C. overnight to obtain Si—Cl. However, other times for incubation are possible, including one hour or more. Other temperatures can also be used, such as room temperature and higher. In one embodiment, the capillary can be cut into 1-2 meter segments to improve flow and reduces capillary clogging for the subsequent steps. FIG. 5 is a block diagram showing, by way of example, chlorination 50, including the chemical reaction mechanism 51 during generation of a Vilsmeier-Haack reagent and conversion of the Si—OH bond on the capillary surface to Si—Cl upon using the reagent.

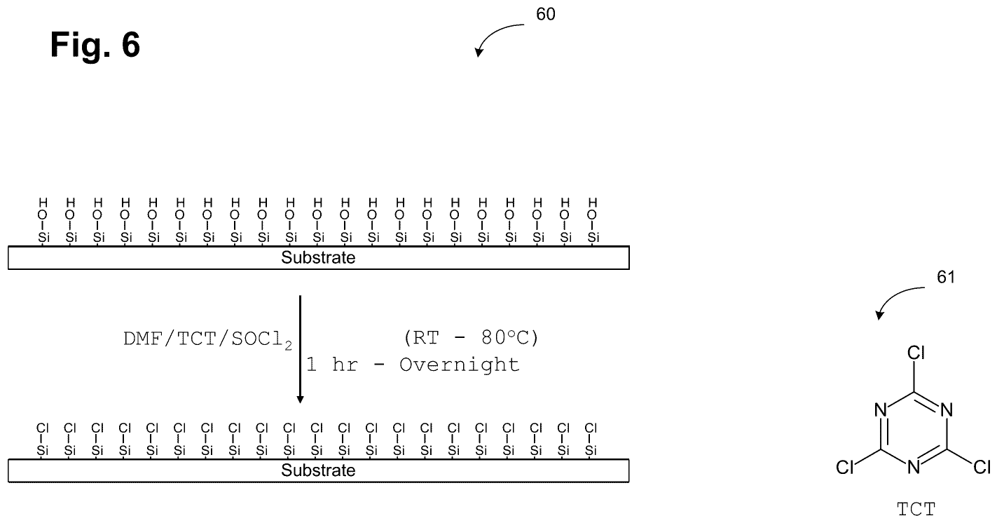

In yet a further embodiment, a different process for converting the Si—OH surface of the capillary to an Si—Cl surface can be performed, including using the Vilsmeier-Haack reagent with the addition of Trichlorotriazine (TCT), also known as Cyanuric acid. TCT acts as a second chlorination agent in this case. It can be used as a single agent without SOCl₂ in other cases. In this process, the reagent for modifying the capillary surface can be made by dissolving TCT in DCM, chlorobenzene, or THF. SOCl₂ can be added slowly, such as by using a dropper, and mixed properly. After, DMF can be added and allowed to diffuse into the solution for a period of time, such as 1 to 2 minutes, before mixing. Other periods of time are possible. Fast mixing the DMF can cause an aggressive reaction, which is undesirable. Subsequently, the capillary can be filled with the mixture, which can include 25% (v/v) SOCl₂+2% (w/v) TCT+25% (v/v) DMF (catalyst) in DCM, chlorobenzene, or THF and incubate at 80° C. overnight. (less incubation time such as 1 hr also possible). Other mole compositions for SOCl₂ TCT, and DMF are possible. For instance, DMF can be as low as 0.01%, TCT can be as low as 0.01%, while SOCl₂ can be as low as 0.01%. In one embodiment, only the listed components are included in the mixture. However, in a further embodiment, any balance remaining of the mixture can be fulfilled with water or another substance. In one embodiment, the capillary can be cut into 1-2 meter segments to improve flow and reduces capillary clogging for the subsequent steps. FIG. 6 is a block diagram showing, by way of example, modification 60 of the Si—OH bonds on the capillary surface to Si—Cl bonds and the chemical structure of TCT 61. For the chlorination processes described above, SOCl₂ can be replaced with other chlorination reagents such as phosphorus oxychloride (POCl₃) and others.

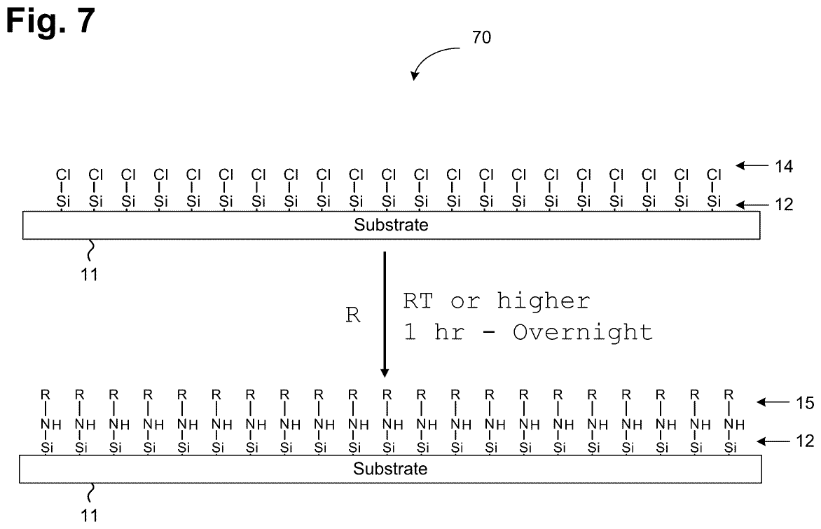

Returning to the discussion with respect to FIG. 2, amination of the capillary surface can be performed (step 23), during which the Si—Cl capillary surface can be converted to Si—NRₓ, where NRₓ is an amine group and R is any monomeric compound, including tris(hydroxymethyl)aminomethane. In one embodiment, the capillary can be filled with any compound having an amine group, such as 1M tris(hydroxymethyl)aminomethane. Flushing of the capillary with the compound should continue until the liquid at an outlet of the capillary is visibly clear. After, the flushed capillary can be incubated at around 80° C. for an hour or more. Other temperatures for incubation are possible, including from room temperature to 200° C., depending on the reagent's thermal stability. FIG. 7 is a block diagram showing, by way of example, modification of the Si—Cl bonds on the capillary surface to Si—N—R bonds. The capillary can be used for electrophoresis after amination or a further, optional step can be performed prior to use.

In a further embodiment of the amination step, transfer chain reaction can be performed. In this case, the capillary can be filled with a freshly prepared mixture of acrylamide and Iron (III) Chloride (FeCl₃). For example, a mixture of 4% (w/v) or less acrylamide and 4% (w/v) or less FeCl₃ (or an equivalent Lewis acid such as AlCl₃) can be prepared. In one embodiment, only the listed components are included in the mixture. However, in a further embodiment, any balance remaining of the mixture can be fulfilled with water or another substance. The acrylamide mixture is flushed through the capillary until the liquid at the outlet of the capillary is visibly yellowish. Next, the capillary can be incubated at room temperature or higher for one or more hours to allow the FeCl₃ to react. During the reaction, the Iron Chloride catalyzes the reaction whereby the acrylamide replaces the chloride on the silica surface of the capillary. Acrylamide can be replaced with any alkylamine or other compounds with an olefin group. Other methods for creating the transfer chain layer are possible, such as treatment with Alkyl Magnesium Chloride (Grignard reagent) or other reagents that introduce a terminal double bond for polymer initiation.

After amination, polymerization can be performed (step 24) as provided in FIG. 2. During polymerization, polymers are formed on the silica surface. As the polymers form, they cover the surface, which reduces EOF, if neutral, and prevent protein adsorption. To initiate the polymerization, the capillary can be filled with a freshly prepared polymerization reagent. For example, a neutral linear polyacrylamide reagent can include 4% (w/v) acrylamide/0.04% (w/v) APS (133 μL of 30% (w/v) acrylamide+4 μL of 10% (w/v) APS per 1 mL). In one embodiment, only the listed components are included in the mixture. However, in a further embodiment, any balance remaining of the mixture can be fulfilled with water or another substance.

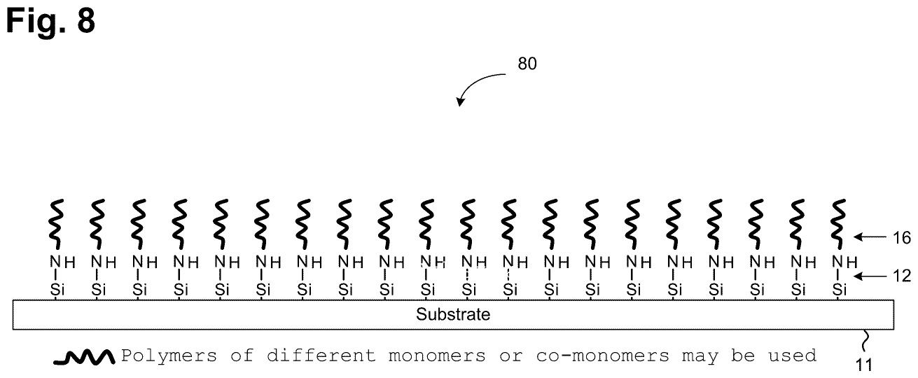

The capillary with the polymerization reagent can be incubated at around 50° C. for around 30-45 minutes. Other incubation temperatures and times are possible. For example, the capillary and reagent can be incubated at room temperature under pressure, such as 2 psi or higher, or at room temperature in the presence of a catalyst, such as tetramethylethylenediamine (TEMED). After incubation, the capillary can be rinsed with water until the flow is visibly watery. FIG. 8 is a block diagram showing, by way of example, an interior 80 of the capillary after polymerization. Silicon 12 on the capillary surface 11 is bonded with amine from which at least one polymer chain 16 is formed.

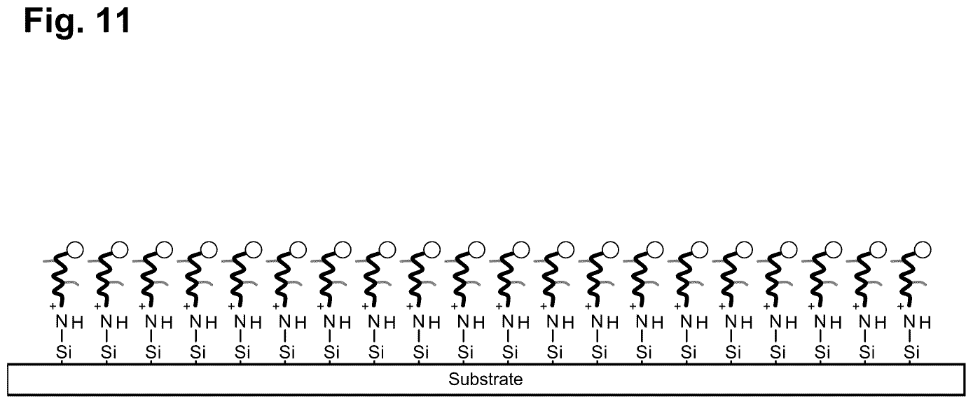

Once the capillary surface has been modified, the capillary can be used for electrophoresis. FIG. 11 is a block diagram showing, by way of example, an interior of the capillary with polymer chains. Silicon 12 on the capillary surface 11 is bonded with an amine, carbon containing, or oxygen containing group on which at least one polymer chain is formed. Free ends or heads of the polymer chain and any side chains can be positively or negatively charged ionic groups. Surface modification to Si—NR or Si—N-Polymer can modulate the EOF in the capillary during CE separation depending on the charge states of the R or the Polymer groups. With an acidic, pH 5 or less, background electrolyte, the N of the Si—NR or S—N-Polymer surface can be protonated. Under an applied electric field, the EOF flows towards the anode (positive electrode). This leads to a reverse EOF, opposite of the normal EOF in an uncoated Si—OH capillary surface. The R group of the Si—NR may also be configured to tune the magnitude and direction of the EOF. The Polymer group can also be configured to achieve the same outcome. This EOF tunability is an important feature of the modification process.

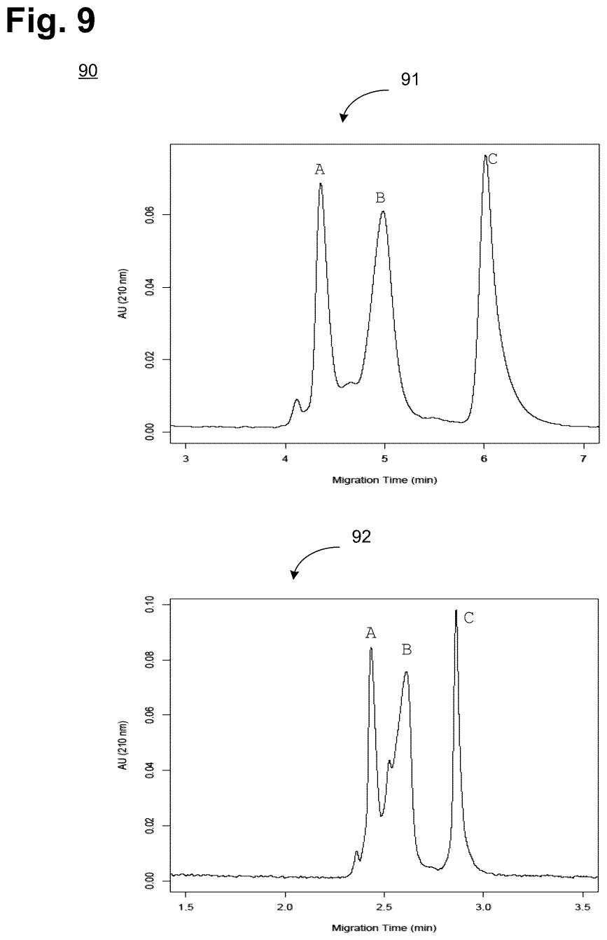

FIG. 9 is a graph diagram showing results of capillary electrophoresis using capillaries with different surface coatings. Prior to the electrophoresis, proteins were prepared in de-ionized distilled water at 1 mg/mL. One graph 90 represents results of electrophoresis using an Si—N—R coated capillary. The capillary had dimensions of 45 cm length, 360 μm o.d., and 50 μm i.d., with 20 kV separation voltage applied. Effective length from inlet to the UV detector was 30 cm. Capillaries with different dimensions can also be used.

A second graph 91 provides results of electrophoresis using an LPA capillary. The LPA capillary is similar to the capillary used during electrophoresis represented by the graph above, but was modified with LPA. When comparing the results of the two graphs, Proteins A, B, and C are more defined and visible in graph 1 than in graph 2, which can be due to a residual reverse EOF using the Si—N—R capillary of graph 1. The amine group of the Si—N—R surface is protonated in an acidic condition. The resulting ammonium ion generates a reverse EOF but the electrophoretic mobility of Proteins A, B, and C seems to be stronger than the reverse EOF, creating a net cathodic mobility.

Different types of polymerization reagents can be used. For instance, in a different embodiment, an aqueous polymerization mixture of acrylamide-polyethylene glycol methacrylate (PEGM) monomer having 0.08% (v/v) TEMED, as a catalyst, and 0.04% (w/v) APS, as an initiator, can be used. Acrylamide can be used in an amount of around 3% (w/v), while PEGM can be used in the amount of 1% (v/v) and the remainder is water. PEG can be added to generate a superior resolution in near-neutral pH than conventional LPA. The improved resolution with the LPA-PEGM coating may be due to enhanced hydrophilicity of the surface and less interaction with proteins. An LPA-PEGM capillary can have dimensions of 1-meter length and standard 50 μm inner diameter. However, other dimensions are possible.

Once the polymerization mixture with LPA-PEGM is generated, the capillary is filled with the polymerization mixture and ends of the capillary are immersed into microfuge tubes filled with the mixture. Other percentages of TEMEP and APS are possible, including in the range of 0-1% or greater. In one embodiment, PEGM can include poly(ethylene glycol) methyl ether methacrylate; however, other derivatives are possible.

The polymerization reaction can be allowed to proceed for 30 minutes or more at room temperature or higher, resulting in a growth of polymer covalently affixed to the silica surface. The reaction mixture is removed from the capillary by rinsing with water, dried with nitrogen gas and stored at 4° C. until use. Other temperatures are possible, including in the range of 2-8° C., room temperature, or −20° C. The presence of PEGM appears to enhance the polymer network hydrophilicity. Preliminary analyses of charge variants on the LPA-PEGM coated capillary showed outstanding results.

Once the capillary is prepared, free zone CE can be used to perform protein separation of a sample. Results of the protein separation can be further analyzed, such as by using mass spectrometry.

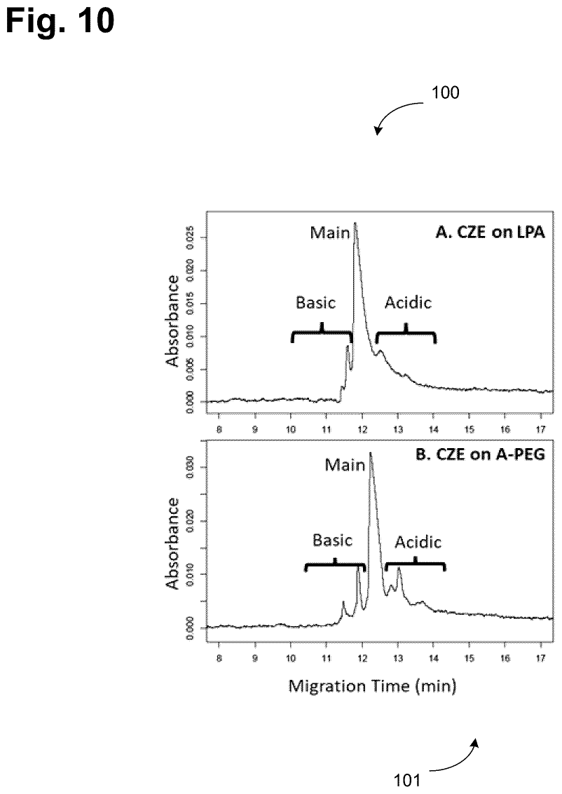

In one example, a particular application of the LPA-PEGM capillary is analysis of charge variants in biotherapeutic protein products. FIG. 10, which is provided below, shows (A) the UV electropherograms 100 generated with an LPA capillary and (B) with an LPA-PEGM capillary 101 for a biotherapeutic protein. The electropherogram generated with an LPA capillary suggests there are charge variants (Basic and Acidic) that differ from the intended biologics product (Main). However, the resolution of the separated analyte is not as good as the profile generated by the LPA-PEGM capillary. Finally, the separation using an LPA-PEGM capillary generates a profile with sufficient resolution of the charge variants without components that interfere with mass spectrometry.

For both LPA and LPA-PEGM profiles, the separation conditions were 50 mM ammonium acetate BGE at pH 5.0, +20 kV separation voltage, +2 kV ESI voltage, on a 50 μm i.d.×360 μm o.d.×50 cm length. The CE separations were coupled to a Thermo Fisher Q Exactive Plus using 0.1% (v/v) formic acid in 20% (v/v) acetonitrile ESI buffer and +2.0 kV ESI voltage. The average LPA-PEGM resolution between the Basic peaks and the Main peak was calculated to be 4.5, which is 4× better than the LPA capillary and better than any previously reported charge variants analysis by CE-MS. The resolution was estimated to be equivalent of 0.05 pl units.

Accordingly, the LPA-PEG coating can permit CE separation in near neutral pH and hyphenation with MS, as well as allow tunability of the BGE and pH to achieve optimal resolution for different proteins. The LPA-PEG coated capillary is used to develop native CE and native ESI conditions with a protein standard mixture, and the native methodology is employed to characterize charge variants of a biotherapeutic protein.

Although the coating modification processes were described above with reference to a silica capillary, the processes can also be used to coat any substrate that present —OH or —COOH groups on the surface. Other types of surfaces can include ceramic, polymers, and other silicon based materials.

While the invention has been particularly shown and described as referenced to the embodiments thereof, those skilled in the art will understand that the foregoing and other changes in form and detail may be made therein without departing from the spirit and scope of the invention.

What is claimed is:

1. A method for coating a surface of fused silica material, comprising:
preconditioning a surface of a piece of material with a hydrolyzing reagent creating an Si—OH or R—OH bond on the surface;
treating the surface with thionyl chloride for a predetermined amount of time converting the Si—OH bond on the surface to an Si—Cl;
removing the thionyl chloride;
treating the surface with a compound or mixture comprising an amine group or an alkyl group converting the Si—Cl bond to an Si—N—R bond, Si—O—R, Si—C—R bond and
removing the compound or mixture.

2. A method according to claim 1, further comprising:
incubating the surface with the thionyl chloride at around 80 C.

3. A method according to claim 1, wherein the thionyl chloride is mixed with dichloromethane, chlorobenzene or tetrahydrofuran prior to processing the surface.

4. A method according to claim 1, wherein the thionyl chloride is mixed with dimethyl formamide in dichloromethane, chlorobenzene or tetrahydrofuran prior to processing the surface.

5. A method according to claim 1, wherein the thionyl chloride is mixed with trichlorotriazine and dimethyl formamide in chloromethane, chlorobenzene or tetrahydrofuran.

6. A method according to claim 1, wherein the amine compound comprises tris(hydroxymethyl)aminomethane or equivalent, a mixture of acrylamide and iron chloride, or a Lewis acid.

7. A method according to claim 1, wherein the alkyl compound comprises Alkyl Magnesium Chloride (Grignard reagent) or other reagents that introduce a terminal double bond for polymer growth.

8. A method according to claim 1, wherein the R group is neutral, positively charged or negatively charged.

9. A method according to claim 1, wherein the R group modulates an electroosmotic flow over the surface so that the electroosmotic flow moves towards an anode on one end of the surface.

10. A method according to claim 1, wherein the R group presents a terminal olefin group to initiate polymerization.

11. A method according to claim 1, further comprising:
covering the surface with a polymerization reagent resulting in growth of polymer chains affixed to the surface via the Si—N—R bond, Si—O—R bond, or Si—C—R bond.

12. A method according to claim 11, further comprising:
generating the polymerization reagent by mixing acrylamide and ammonium persulfate.

13. A method according to claim 11, further comprising:
generating the polymerization reagent by mixing acrylamide, polyethylene glycol, tetramethylethylenediamine, and ammonium persulfate.

14. A method according to claim 11, further comprising:
incubating the capillary with the polymerization agent at around 50° C. for 30-45 min or at room temperature under pressure, or at RT in the presence of a catalyst.

15. A method according to claim 11, wherein the polymer chains modulate an electroosmotic flow over the surface so that the electroosmotic flow moves towards an anode on one end of a surface.

16. A modified capillary, comprising:
an Si—N—R bond, Si—O—R, or Si—C—R bond formed on an interior surface.

17. A modified capillary according to claim 15, wherein the R group is neutral, positively charged or negatively charged, and modulates an electroosmotic flow over the surface so that the electroosmotic flow moves towards an anode on one end of the surface.

18. A modified capillary, comprising:
an Si—N—R bond, Si—O—R, or Si—C—R bond formed on an interior surface; and
one or more polymer chains affixed to the surface via the Si—N—R bond, Si—O—R bond, or Si—C—R bond.

19. A modified capillary according to claim 18, wherein the R group presents a terminal olefin group to initiate polymerization.

20. A modified capillary according to claim 18, wherein the polymer chains modulate an electroosmotic flow over the surface so that the electroosmotic flow moves towards an anode on one end of a surface.
